(19) United States
(12) Patent Application Publication
(10) Pub. No.: US 2013/0073944 A1
(43) Pub. Date: Mar. 21, 2013

(54) METHOD AND SYSTEM FOR DYNAMICALLY PROVIDING CONTEXTUALLY RELEVANT POSTS ON AN ARTICLE

(71) Applicants: Amit Motgi, Santa Clara, CA (US); Ali Satter, San Jose, CA (US); Bruce Ng, Santa Clara, CA (US)

(72) Inventors: Amit Motgi, Santa Clara, CA (US); Ali Satter, San Jose, CA (US); Bruce Ng, Santa Clara, CA (US)

(73) Assignee: Yahoo! Inc., Sunnyvale, CA (US)

(21) Appl. No.: 13/233,450

(22) Filed: Sep. 15, 2011

(51) Int. Cl. G06F 17/00

(52) U.S. Cl. 715/234

(57) ABSTRACT

A method and system for dynamically providing contextually relevant posts on an article. The method includes extracting a list of key terms from the article on a web page. The method also includes filtering out a first set of live posts associated with a first key term in the list of key terms. The method further includes displaying the list of key terms from the article along with the first set of live posts associated with the first key term in the list of key terms. The system includes one or more electronic devices, a communication interface, a memory, and a processor.

### TECHNICAL FIELD

Embodiments of the disclosure relate to the field of dynamically providing contextually relevant posts on an article.

### BACKGROUND

Currently, a user reads or browses through an article on the internet in brief since there is insufficient contextually relevant information to increase attention span of the user. Hence, the user tends to search for other contextually relevant information outside a network, thereby leading to a loss in revenue for the network. Moreover, traffic recirculation in the network decreases if the user is unsatisfied with content present on the network.

In the light of the foregoing discussion, there is a need for a method and system for an efficient technique to dynamically provide contextually relevant posts on an article.

### SUMMARY

The above-mentioned needs are met by a method, a computer program product and a system for dynamically providing contextually relevant posts on an article.

An example of a method of dynamically providing contextually relevant posts on an article includes extracting a list of key terms from the article on a web page. The method also includes filtering out a first set of live posts associated with a first key term in the list of key terms. The method further includes displaying the list of key terms from the article along with the first set of live posts associated with the first key term in the list of key terms.

An example of a computer program product stored on a non-transitory computer-readable medium that when executed by a processor, performs a method of dynamically providing contextually relevant posts on an article includes extracting a list of key terms from the article on a web page. The computer program product also includes filtering out a first set of live posts associated with a first key term in the list of key terms. The computer program product further includes displaying the list of key terms from the article along with the first set of live posts associated with the first key term in the list of key terms.

An example of a system for dynamically providing contextually relevant posts on an article includes one or more electronic devices. The system also includes a communication interface in electronic communication with the one or more electronic devices. The system further includes a memory that stores instructions. Further, the system includes a processor responsive to the instructions to extract a list of key terms from the article on a web page, to filter out a first set of live posts associated with a first key term in the list of key terms, and to display the list of key terms from the article along with the first set of live posts associated with the first key term in the list of key terms.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment;

FIG. 3 is a flowchart illustrating a method of dynamically providing contextually relevant posts on an article, in accordance with one embodiment; and

FIG. 4 is an exemplary representation of a web page, in accordance with one embodiment.

### DETAILED DESCRIPTION OF THE EMBODIMENTS

The above-mentioned needs are met by a method, computer program product and system for dynamically providing contextually relevant posts on an article. The following detailed description is intended to provide example implementations to one of ordinary skill in the art, and is not intended to limit the invention to the explicit disclosure, as one or ordinary skill in the art will understand that variations can be substituted that are within the scope of the invention as described.

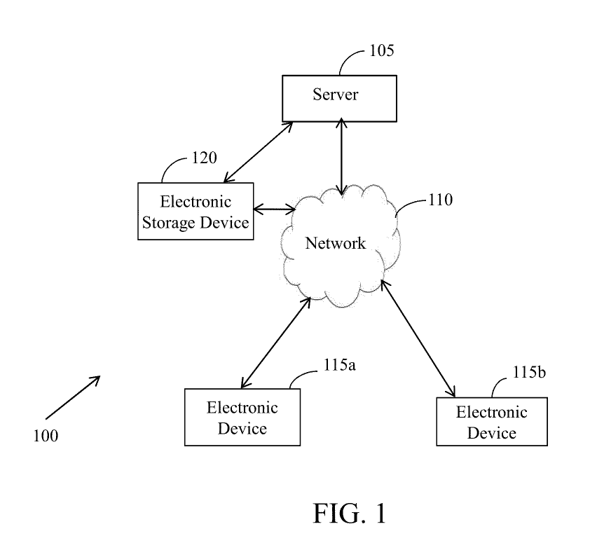

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example a list of key terms, a first set of live posts, and a second set of live posts.

In some embodiments, different electronic storage devices are used for storing the information.

A user of an electronic device, for example the electronic device 115a, can view an article on a web page. A list of key terms from the article and a first set of live posts associated with a first key term in the list of key terms are displayed along with the article. The user can provide a response to one or more live posts in the first set of live posts. The user can also select another key term from the list of key terms and the web page is updated with a corresponding set of live posts. The user can be directed to another web page if an associated uniform resource locator (URL) , for example a Yahoo!® URL, was selected from one of the live posts. The server 105, for example a Yahoo!® server, is used to extract the list of key terms from the article, filter out the first set of live posts from one or more networking websites, and update the web page with the corresponding set of live posts associated with a key term that is selected by the user. The electronic storage device 120 can store the list of key terms, the first set of live posts, and the second set of live posts.

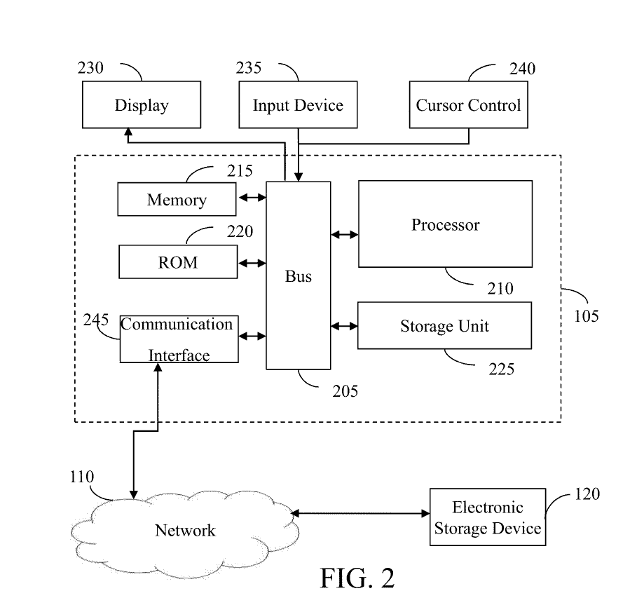

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example the list of key terms, the first set of live posts, and the second set of live posts.

The server 105 can be coupled via the bus 205 to a display 230, for example a cathode ray tube (CRT), and liquid crystal display (LCD) for displaying the list of key terms from the article along with the first set of live posts associated with the first key term to the user. An input device 235, including alphanumeric and other keys, is coupled to bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the list of key terms, the first set of live posts, and the second set of live posts.

The processor 210 in the server 105, for example a Yahoo!® server, extracts the list of key terms from the article on the web page. The processor 210 filters out a first set of live posts associated with a first key term in the list of key terms. The processor 210 further enables display of the list of key terms from the article along with the first set of live posts associated with the first key term in the list of key terms. The processor 210 also updates the web page with a second set of live posts associated with a second key term which is selected from the list of key terms by the user. The user can then provide a response to one or more live posts in at least one of the first set of live posts and the second set of live posts.

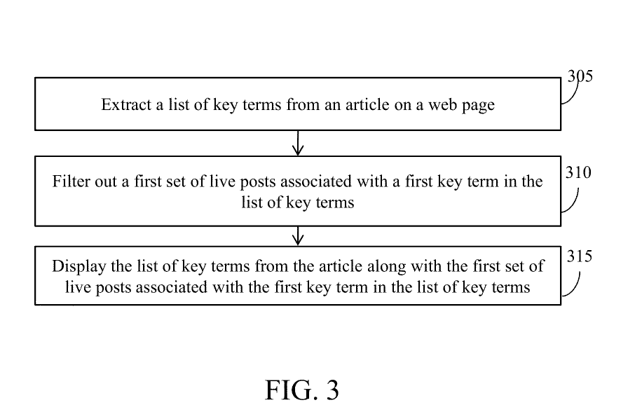

FIG. 3 is a flowchart illustrating a method of dynamically providing contextually relevant posts on an article, in accordance with one embodiment. Posts can be defined as messages posted on a website in association with a topic of conversation, and live posts are the messages that are being streamed live as and when uploaded by users. Key terms are words or phrases in the article that are important in defining the article.

At step 305, a list of key terms is extracted from the article on a web page. The list of key terms is extracted from the article by a server, for example the server 105. When a user of an electronic device, for example the electronic device 115a, visits the web page to view the article, the user can also view the list of key terms that is extracted from the article.

In some embodiments, the list of key terms can be extracted using a term extraction application programming interface (API), for example Yahoo!® Term Extraction API, through a query language, for example Yahoo!® Query Language (YQL).

The list of key terms can be stored at the server or an electronic storage device, for example the electronic storage device 120, and is retrieved as required. In one example, the server can be a centralized server or a distributed server of Yahoo!®.

At step 310, a first set of live posts associated with a first key term in the list of key terms is filtered out. The first key term in the list of key terms is identified and a search is subsequently performed for the first set of live posts associated with the first key term. The first set of live posts can be filtered out from a single networking website or multiple networking websites.

In some embodiments, one or more live posts in the first set of live posts can include textual conversation between a plurality of users, uniform resource locators (URLs), or a combination of both.

In some embodiments, the one or more live posts in the first set of live posts can be filtered out based on nonspecific URLs. In other embodiments, the one or more live posts in the first set of live posts can be filtered out based on specific URLs, for example Yahoo!® URLs.

In some embodiments, the first set of live posts associated with the first key term can be filtered out from the networking websites using a search algorithm.

At step 315, the list of key terms from the article is displayed along with the first set of live posts associated with the first key term in the list of key terms. Hence, when the user of the electronic device visits the web page to view the article, the user can also view the list of key terms and the first set of live posts associated with the first key term in the list of key terms.

In some embodiments, the list of key terms and the first set of live posts are displayed in extensible markup language (XML) format, in hypertext markup language (HTML) format, or in JavaScript Object Notation (JSON) format.

In some embodiments, the user can provide a response to the one or more live posts in the first set of live posts. Examples of the response include, but are not limited to, a reply to a live post, and adding the live post as a preferred post on the web page. The reply can be posted to at least one of the web page and the networking website.

In some embodiments, the user can further select a second key term from the list of key terms. A key term other than the first key term in the list of key terms can be referred to as the second key term. The web page is then updated with a second set of live posts associated with the second key term. The user can further provide the response to one or more live posts in the second set of live posts.

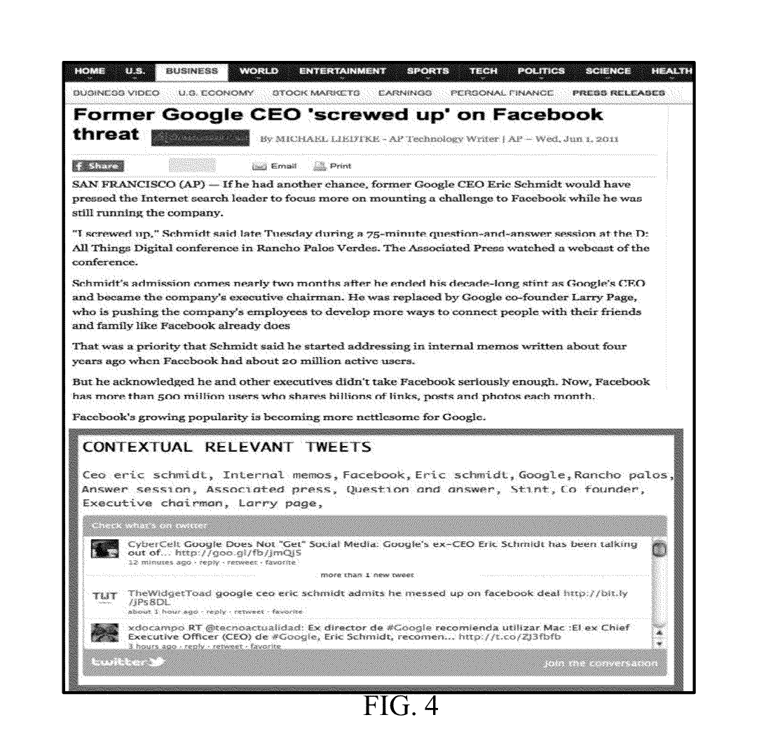

FIG. 4 is an exemplary representation of a web page, in accordance with one embodiment. A user visits a web page on Yahoo!® News to read a news article that discusses a former Google CEO. A server, for example the Yahoo!® server, extracts a list of key terms, for example ceo eric schmidt and internal memos, from the news article that are relevant. The server also filters out a first set of live posts, for example contextual relevant tweets, associated with a first key term, for example ceo eric schmidt, in the list of key terms. The first set of live posts can be filtered out from one or more networking websites, for example Twitter. One or more live posts in the first set of live posts can include textual conversation regarding Eric Schmidt, Yahoo!® URLs, or a combination of both. The user can then view the list of key terms and the first set of live posts associated with the first key term along with the news article. The user can further select another key term, for example Facebook, from the list of key terms. The user can then view an updated web page with the article, the list of key terms, and a set of live posts corresponding to the key term Facebook. The user can also reply to a live post or can add the live post as a preferred post. The reply can be posted to at least one of the web page and the networking website.

The present disclosure dynamically provides contextually relevant posts on an article by extracting a list of key terms from the article. On the web page, the user can directly view live posts, corresponding to different key terms, which are filtered out from one or more networking websites and that are related to the article. The present disclosure hence provides a contextually relevant and engaging experience to the user. Further, traffic can be recirculated within a network, for example the Yahoo!® network, by filtering the live posts based on specific URLs, for example Yahoo!® URLs. Revenue can also be increased due to increased engagement, increased page views due to traffic recirculation, and increased time spent on the web page.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of dynamically providing contextually relevant posts on an article, the method comprising:
extracting a list of key terms from the article on a web page;
filtering out a first set of live posts associated with a first key term in the list of key terms; and
displaying the list of key terms from the article along with the first set of live posts associated with the first key term in the list of key terms.

2. The method as claimed in claim 1, wherein filtering out the first set of live posts comprises:
identifying the first key term in the list of key terms; and
performing a search for the first set of live posts associated with the first key term in the list of key terms.

3. The method as claimed in claim 2, wherein the first set of live posts is filtered out from one of a single networking website and multiple networking websites.

4. The method as claimed in claim 1 and further comprising updating the web page with a second set of live posts associated with a second key term, wherein the second key term is selected from the list of key terms by a user.

5. The method as claimed in claim 4 and further comprising
enabling the user to provide a response to one or more live posts in at least one of the first set of live posts and the second set of live posts.

6. The method as claimed in claim 5, wherein the response comprises at least one of replying to a live post, and
adding the live post as a preferred post.

7. The method as claimed in claim 5, wherein the one or more live posts comprises at least one of textual conversation between a plurality of users and uniform resource locators.

8. The method as claimed in claim 7, wherein the uniform resource locators comprises nonspecific uniform resource locators and specific uniform resource locators.

9. The method as claimed in claim 1, wherein the list of key terms is extracted from the article using a term extraction application programming interface.

10. A computer program product stored on a non-transitory computer-readable medium that when executed by a processor, performs a method of dynamically providing contextually relevant posts on an article, comprising:
extracting a list of key terms from the article on a web page;
filtering out a first set of live posts associated with a first key term in the list of key terms; and
displaying the list of key terms from the article along with the first set of live posts associated with the first key term in the list of key terms.

11. The computer program product as claimed in claim 9, wherein filtering out the first set of live posts comprises:
identifying the first key term in the list of key terms; and
performing a search for the first set of live posts associated with the first key term in the list of key terms.

12. The computer program product as claimed in claim 11, wherein the first set of live posts is filtered out from one of a single networking website and multiple networking websites.

13. The computer program product as claimed in claim 10 and further comprising
updating the web page with a second set of live posts associated with a second key term, wherein the second key term is selected from the list of key terms by a user.

14. The computer program product as claimed in claim 13 and further comprising
enabling the user to provide a response to one or more live posts in at least one of the first set of live posts and the second set of live posts.

15. The computer program product as claimed in claim 14, wherein the response comprises at least one of
replying to a live post, and
adding the live post as a preferred post.

16. The computer program product as claimed in claim 14, wherein the one or more live posts comprises at least one of textual conversation between a plurality of users and uniform resource locators.

17. The computer program product as claimed in claim 16, wherein the uniform resource locators comprises nonspecific uniform resource locators and specific uniform resource locators.

18. The computer program product as claimed in claim 10, wherein the list of key terms is extracted from the article using a term extraction application programming interface.

19. A system for dynamically providing contextually relevant posts on an article, the system comprising:
one or more electronic devices;
a communication interface in electronic communication with the one or more electronic devices;
a memory that stores instructions; and
a processor responsive to the instructions to
extract a list of key terms from the article on a web page;
filter out a first set of live posts associated with a first key term in the list of key terms; and
display the list of key terms from the article along with the first set of live posts associated with the first key term in the list of key terms.

20. The system as claimed in claim 19, wherein the processor is further responsive to the instructions to
update the web page with a second set of live posts associated with a second key term, wherein the second key term is selected from the list of key terms by a user.

21. The system as claimed in claim 20, wherein the processor is further responsive to the instructions to
enable the user to provide a response to one or more live posts in at least one of the first set of live posts and the second set of live posts.

22. The system as claimed in claim 21 and further comprising
an electronic storage device that stores the list of key terms, the first set of live posts, and the second set of live posts.
